(19) United States
(12) Patent Application Publication
(10) Pub. No.: US 2006/0256548 A1
(43) Pub. Date: Nov. 16, 2006

(54) Lifesaving lighting hammer

(76) Inventor: Siu Chan Wong, Hong Kong (HK)

Correspondence Address: J.C Patents, Suite 250, 4 Venture, Irvine, CA, 92618, US

(21) Appl. No.: 11/339,051

(22) Filed: Jan. 24, 2006

(30) Foreign Application Priority Data
May 16, 2005 (CN) 200520018073.X

(51) Int. Cl. B25B 23/18

(52) U.S. Cl. 362/119

(57) ABSTRACT

The present utility model relates to a lifesaving lighting hammer including a head, which consists of a hammer tip and a tail, and a stem in which a battery groove for holding a battery is arranged. An illuminant is arranged at one end of the hammer stem, in which a generating set is provided. The generating set and the aforesaid battery are electrically connected with the illuminant respectively to thereby form two sets of power supply systems. The present utility model overcomes the publicly known defects and prolongs lighting time of the illuminant effectively.

This application claims the priority benefit of Chinese Utility Model application No. 200520018073.X, the contents of which is hereby incorporated by reference in its entirety.

### TECHNICAL FIELD

The present utility model relates to a lifesaving lighting hammer used in vehicles like automobile.

### BACKGROUND ART

Nowadays, automobile is a relatively popular vehicle; however, traffic accidents are gradually increased. When an accident occurs, driver easily gets trapped due to the locked door and seat belt cannot be released. For solving the problem, people devise a multifunctional hammer, for example, Chinese utility model patent which has been granted by an announcement number CN2338144Y and is entitled “multi-functional hammer for lifesaving for automobile driver”. This publicly known multifunctional automobile hammer consists of head, stem, and tail. The head is made up of hammer tip having top end for smashing car windows. The hammer stem is mounted with blade and knifepoint shield for cutting the safe belt without wounding hands. The hammer stem and tail are also provided with a flashlight which enables bulb lightening.

However, this conventional multi-functional hammer uses battery to supply power to the bulb. Battery's work time is very short; therefore, the battery for supplying power can not meet user's requirement when a longer time is needed to get out of a trap.

### SUMMARY OF THE INVENTION

The object of the present utility model is to provide a lifesaving lighting hammer which prolongs lighting time of an illuminant by using two sets of power supply systems.

Another object of the present utility model is to provide a multi-functional lifesaving lighting hammer which has several lifesaving tools, thereby improving practicability of the lifesaving lighting hammer.

In order to achieve the aforesaid objects, this utility model presents a lifesaving lighting hammer including a head, which consists of a hammer tip and a tail, and a stem in which a battery groove for holding a battery is arranged. An illuminant is arranged at one end of the hammer stem, characterized in that a generating set is provided in the hammer stem. The generating set and the aforesaid battery are electrically connected with the illuminant respectively to thereby form two sets of power supply systems.

Said power supply system comprises a switcher.

Said generating set comprises a generator, a rectifying bridge and electricity storage. Said generator is electrically connected with the electricity storage through the rectifying bridge. Said electricity storage is electrically connected with the aforesaid illuminant.

Said generating set further comprises a handle and a driving gear. The driving gear has coaxially disposed large axial end and small axial end. The handle has one end fixed to the inside of the hammer stem and the other end rotatably engaged with the small axial end. The large axial end is at the same time engaged with gears in the generator. A part of the other end of the handle is exposed to the hammer stem.

Within said hammer stem, a groove for accommodating an air needle, which is retractably provided in said hammer stem, is disposed.

Said air needle comprises a needle head and a needle holder, of which one end is exposed to the hammer stem and the other end has an elastic leaf. Corresponding to reverse sliding groove of the elastic leaf, the aforesaid air needle accommodating groove is provided with two positioning holes, in which said needle holder is selectively disposed. One end of the needle head is fixed to the inside of the needle holder.

In the middle part of said hammer head, there is disposed a hole, through which the aforesaid illuminant is installed on the aforesaid hammer stem by means of a base.

Said hammer stem is provided with knife head shield and blade positioning pin, on which blades are arranged.

Said hammer stem is provided with normally closed switch and through holes for cutting off the normally closed switch. The normally closed switch is electrically connected with the aforesaid illuminant.

In summary, the present utility model has the following advantages:

1. Due to the use of two sets of power supply systems, the present utility model may switch the generating set to supply power when power supplied by battery is not sufficient, so as to prolong lighting time of the illuminant effectively and overcome publicly known defects.

2. The present utility model enables the generator to generate electricity via hand pressing handle and produces direct current after subjecting to rectifying to be stored in the electricity storage in order to supply power. It can be used conveniently. About hand pressing more than fifteen times, it is able to last about 20 minutes.

3. Due to use of air needle retractable within the hammer stem, the present lifesaving lighting hammer can pierce the gasbag to discharge the air therein, so as to improve practicability of the present lifesaving lighting hammer.

### BRIEF DESCRIPTION OF FIGURES

FIG. 1 is a combination view schematically showing the present utility model.

FIG. 2 is an outside main view of the present utility model.

FIG. 3 is an outside back view of the present utility model.

FIG. 4 is an outside bottom view of the present utility model.

FIG. 5 is an outside top view of the present utility model.

FIG. 6 is an outside right view of the present utility model.

FIG. 7 is an outside left view of the present utility model.

FIGS. 8A-8H are drawings of some parts of the present utility model.

### MODE OF CARRYING OUT THE INVENTION

Technical solution of the present utility model will be described next in detail in conjunction with the drawings.

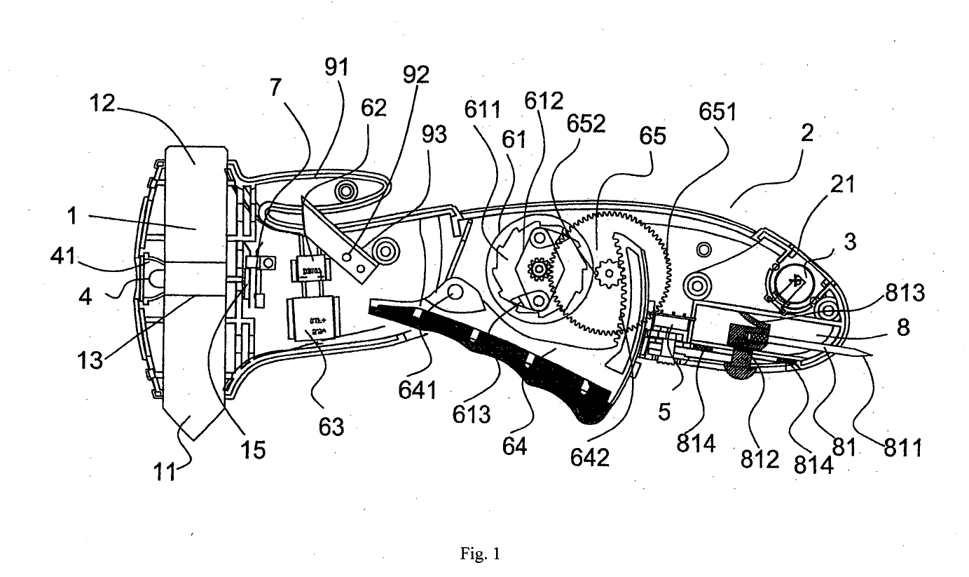

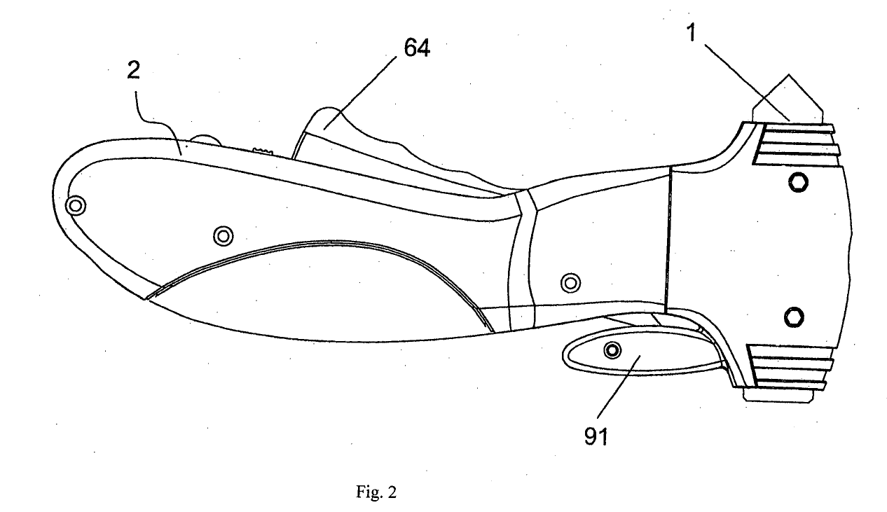

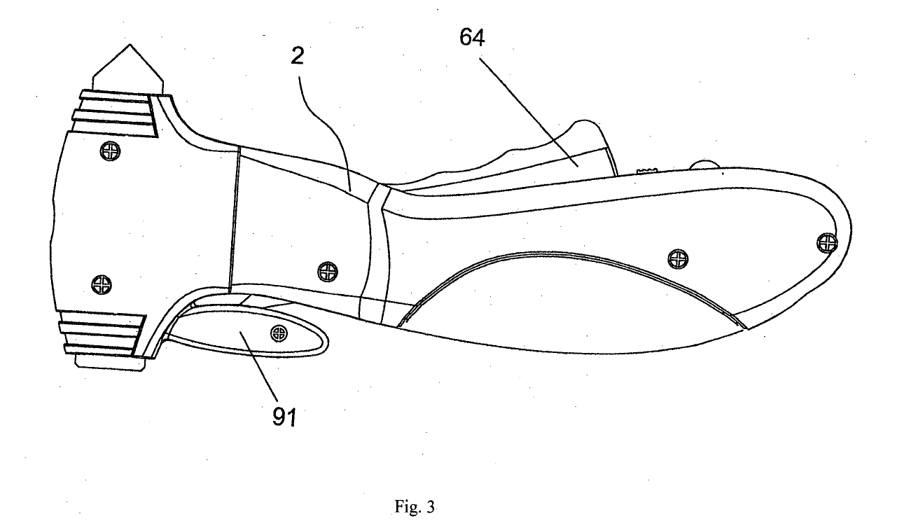

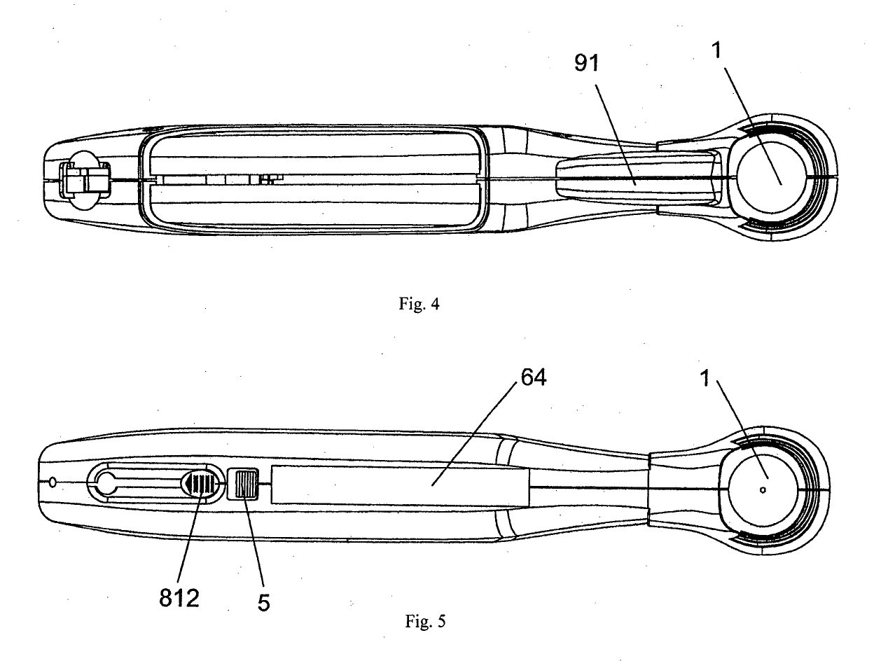

As shown in FIG. 1, the lifesaving lighting hammer presented by the present utility model comprises a head 1, which consists of a hammer tip 11 and a tail 12, and a stem 2 in which a battery groove 21 for holding a battery 3 is arranged. An illuminant 4 is arranged at one end of the hammer stem 2, in which a generating set is provided. The generating set and the aforesaid battery 3 are electrically connected with the illuminant 4 respectively to thereby form two sets of power supply systems. Said power supply systems perform switching via a switcher 5. Said illuminant 4 may be lighting diode.

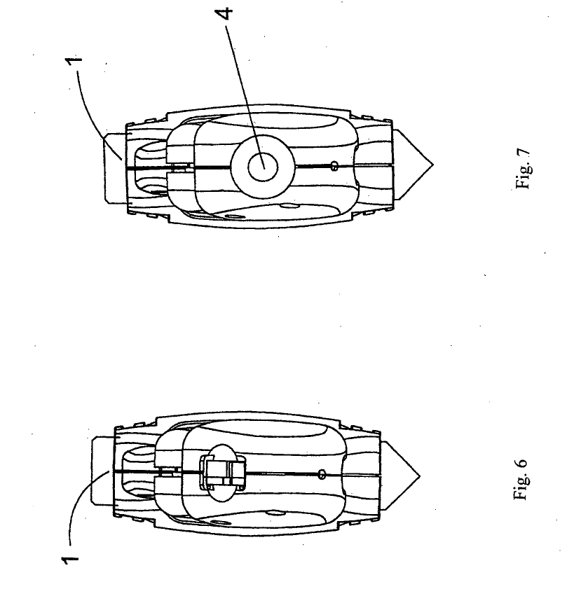

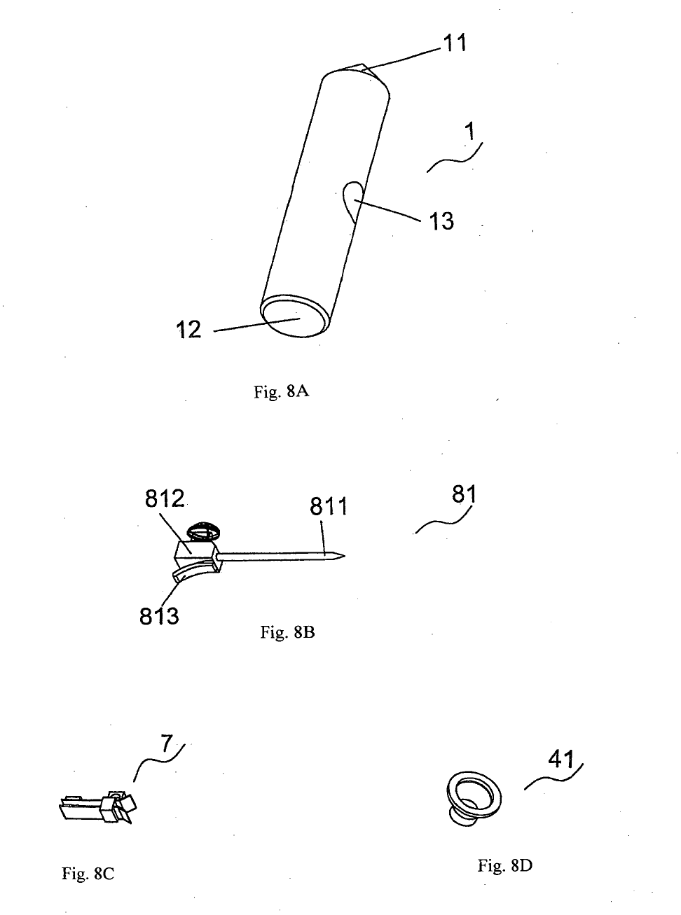

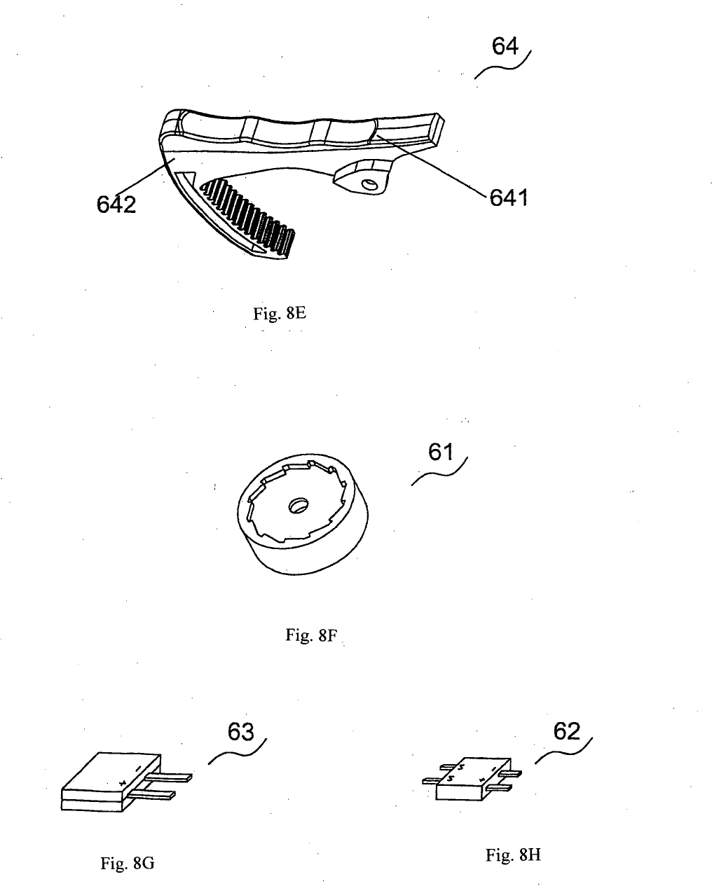

As shown in FIGS. 8E-8H, in this embodiment, the aforesaid generating set comprises a generator 61, a rectifying bridge 62 and electricity storage 63. Through the rectifying bridge 62, said generator 61 is electrically connected with said electricity storage 63 (capacitor). Said electricity storage 63 is electrically connected with the aforesaid illuminate 4. That is, alternating current produced by the generator 61 is switched into direct current through the rectifying bridge 62, and the direct current is stored in the electricity storage 63 so as to supply power. The generator 61 is able to generate electricity in any appropriate way. For example, the generator 61 in the present embodiment generates electricity by means of a handle 64 and a driving gear 65. The driving gear 65 has coaxially disposed large axial end 651 and small axial end 652. The handle 64 has one end 641 fixed to the inside of the hammer stem 2 and the other end 642 rotatably engaged with the small axial end 652. The large axial end 651 is at the same time engaged with gears 612 in the generator. A part of the other end 642 of the handle 64 is exposed to the hammer stem 2. When power supplied by the battery 3 is low, the driving gear 65 is driven to rotate by means of the pressing handle 64, and a claw 613 is stretched when gears 612 is rotated by means of the driving gear 615. The stretched claw 613 drives a flywheel 611 to enable permanent magnet in the flywheel to move by cutting magnetic line of force along internal stator coils of the generator, so that internal stator coils of the generator 61 generate induced electromotive force (induced voltage). That is, the generator 61 generates alternating current and switches the generated alternating current into direct current through the rectifying bridge 62 to be stored in the electricity storage 63, in order to supply power. When power supplied by battery is sufficient, the switcher 5 connects the light emitting diode 4 with the battery 3, so that the battery 3 supplies the light emitting diode 4 with power. When power supplied by battery is low, the switcher 5 switches power supply systems to enable the generating set to supply the light emitting diode 4 with power. To this end, due to the use of two sets of power supply systems, i.e. the battery 3 and generating set, the present utility model may switch the generating set to supply power when power supplied by the battery 3 is not sufficient, so as to prolong lighting time of the illuminant 4.

As shown in FIG. 1 and FIG. 8B, within said hammer stem 2, a groove 8 for accommodating an air needle 81, which is retractably provided in said hammer stem 2, is disposed. When the air needle extends beyond the hammer stem 2, it may pierce the gasbag with its tip. In the present embodiment, said air needle 81 comprises a needle head 811 and a needle holder 812, of which one end is exposed to the hammer stem and the other end has an elastic leaf 813. Corresponding to reverse sliding groove of the elastic leaf 813, the aforesaid air needle accommodating groove 8 is provided with two positioning holes 814. In one of said positioning holes 814, the needle holder 812 is selectively disposed, so that the air needle can be positioned. One end of the needle head 811 is fixed to the inside of the needle holder 812. When the gasbag needs to be pierced, the needle holder 812 is pressed downwardly by fingers and pushed forward completely. Therefore, the needle holder 812 gets into the front positioning hole 814. After letting go of hands, the air needle 812 may bounce up. Hence, the air needle is put to the right place. By using the tip of the air needle 81, the air in the gasbag can be pierced to thereby discharge the air therein.

As shown in FIG. 1 and FIG. 8A, the aforesaid hammer head 1 comprises a tip 11 and a tail 12 which may be formed integrally or separately. The tip 11 is made of hard and stiff steels to breaking car windows to pieces. The tail 12 is in a flat shape for striking. When a driver needs is jammed, he or she must first use the hammer tip 11 to smash the car windows and then use the hammer tail 12 to make glass pieces (knife-edged) flat, and then the driver can save himself or herself. In the middle part of said hammer head 1, there is disposed a hole 13, through which the aforesaid illuminant 4 is installed on the hammer stem 2 of the lifesaving lighting hammer by means of a base 41. On the hammer stem 2, a lampshade is provided corresponding to the light emitting diode 4 for protecting the light emitting diode. The base 41 is able to reflect light beams from the light emitting diode 4, so as to increase degree of brightness.

As shown in FIG. 8C, the aforesaid hammer stem 2 is provided with normally closed switch 7 and through holes 15 for cutting off the normally closed switch 7. The normally closed switch 7 is electrically connected with the aforesaid light emitting diode 4. When two contacts of the normally closed switch 7 is mounted into the base, they will be cut off by projected points of the base; the circuit is cut off, the light emitting diode does not emit light. When the lifesaving lighting hammer is taken out from the base, the two contacts of the normally closed switch 7 meet due to resilience caused by their own elasticity. As a result, the circuit is closed, and the light emitting diode 4 emits light. To this end, the present utility model can be used conveniently.

Said hammer stem 2 is provided with knife head shield 91 and blade positioning pin 92, on which blades 93 are arranged. As shown in FIG. 1, a lance-shaped knife head shield 91 which extends from the hammer stem 2 and is in parallel relationship with the hammer stem is located in the top left part of the hammer stem 2. A space between the knife head shield 91 and the main part of the hammer stem 2 forms a horn-shaped gap which varies from small to large from left to right. A part of edge of the blades 93 and knife body are exposed from the horn-shaped gap for cutting safe belt. In use, a user places the knife head shield 91 into the safe belt and drags it with force, so that the safe belt can be cut off. On the one hand, the aforesaid knife head shield 91 and the main body of the hammer stem form a horn-shaped opening to expose the knife edge; on the other hand, knife tip is wrapped to realize a safe structure.

The aforesaid is only an embodiment of the present utility model and can not be used to limit the scope of the present utility model. That is, any variations and modifications to the claims made according to the present utility model fall into the patent protection scope of the present utility model.

I claim:

1. A lifesaving lighting hammer, comprising a head, which consists of a hammer tip and a tail, and a stem in which a battery groove for holding a battery is arranged, the hammer stem having an illuminant disposed at one end, characterized in that a generating set is provided in the hammer stem, the generating set and the aforesaid battery are electrically connected with the illuminant respectively to thereby form two sets of power supply systems.

2. The lifesaving lighting hammer according to claim 1, characterized in that said power supply system comprises a switcher.

3. The lifesaving lighting hammer according to claim 2, characterized in that said generating set comprises a generator, a rectifying bridge and electricity storage, said generator is electrically connected with the electricity storage through the rectifying bridge, and said electricity storage is electrically connected with the aforesaid illuminant.

4. The lifesaving lighting hammer according to claim 3, characterized in that said generating set further comprises a handle and a driving gear, the driving gear has coaxially disposed large axial end and small axial end, the handle has one end fixed to the inside of the hammer stem and the other end rotatably engaged with the small axial end, the large axial end is at the same time engaged with gears in the generator, a part of the other end of the handle is exposed from the hammer stem.

5. The lifesaving lighting hammer according to claim 1, characterized in that within said hammer stem, a groove for accommodating an air needle, which is retractably provided in said hammer stem, is disposed.

6. The lifesaving lighting hammer according to claim 5, characterized in that said air needle comprises a needle head and a needle holder, one end of the needle holder is exposed from the hammer stem and the other end has an elastic leaf; corresponding to reverse sliding groove of the elastic leaf, the aforesaid air needle accommodating groove is provided with two positioning holes, in which said needle holder is selectively disposed; one end of the needle head is fixed to the inside of the needle holder.

7. A lifesaving lighting hammer according to claim 1, characterized in that in the middle part of said hammer head, there is disposed a hole, through which the aforesaid illuminant is installed on the aforesaid hammer stem by means of a base.

8. A lifesaving lighting hammer according to claim 2, characterized in that in the middle part of said hammer head, there is disposed a hole, through which the aforesaid illuminant is installed on the aforesaid hammer stem by means of a base.

9. A lifesaving lighting hammer according to claim 3, characterized in that in the middle part of said hammer head, there is disposed a hole, through which the aforesaid illuminant is installed on the aforesaid hammer stem by means of a base.

10. A lifesaving lighting hammer according to claim 4, characterized in that in the middle part of said hammer head, there is disposed a hole, through which the aforesaid illuminant is installed on the aforesaid hammer stem by means of a base.

11. A lifesaving lighting hammer according to claim 5, characterized in that in the middle part of said hammer head, there is disposed a hole, through which the aforesaid illuminant is installed on the aforesaid hammer stem by means of a base.

12. A lifesaving lighting hammer according to claim 6, characterized in that in the middle part of said hammer head, there is disposed a hole, through which the aforesaid illuminant is installed on the aforesaid hammer stem by means of a base.

13. A lifesaving lighting hammer according to claim 1, characterized in that said hammer stem is provided with knife head shield and blade positioning pin, on which blades are mounted.

14. A lifesaving lighting hammer according to claim 2, characterized in that said hammer stem is provided with knife head shield and blade positioning pin, on which blades are mounted.

15. A lifesaving lighting hammer according to claim 3, characterized in that said hammer stem is provided with knife head shield and blade positioning pin, on which blades are mounted.

16. A lifesaving lighting hammer according to claim 4, characterized in that said hammer stem is provided with knife head shield and blade positioning pin, on which blades are mounted.

17. A lifesaving lighting hammer according to claim 5, characterized in that said hammer stem is provided with knife head shield and blade positioning pin, on which blades are mounted.

18. A lifesaving lighting hammer according to claim 6, characterized in that said hammer stem is provided with knife head shield and blade positioning pin, on which blades are mounted.

19. A lifesaving lighting hammer according to claim 1, characterized in that said hammer stem is provided with normally closed switch and through holes for cutting off the normally closed switch, which is electrically connected with the aforesaid illuminant.

20. A lifesaving lighting hammer according to claim 2, characterized in that said hammer stem is provided with normally closed switch and through holes for cutting off the normally closed switch, which is electrically connected with the aforesaid illuminant.

21. A lifesaving lighting hammer according to claim 3, characterized in that said hammer stem is provided with normally closed switch and through holes for cutting off the normally closed switch, which is electrically connected with the aforesaid illuminant.

22. A lifesaving lighting hammer according to claim 4, characterized in that said hammer stem is provided with normally closed switch and through holes for cutting off the normally closed switch, which is electrically connected with the aforesaid illuminant.

23. A lifesaving lighting hammer according to claim 5, characterized in that said hammer stem is provided with normally closed switch and through holes for cutting off the normally closed switch, which is electrically connected with the aforesaid illuminant.

24. A lifesaving lighting hammer according to claim 6, characterized in that said hammer stem is provided with normally closed switch and through holes for cutting off the normally closed switch, which is electrically connected with the aforesaid illuminant.
